(19) United States
(12) Patent Application Publication
(10) Pub. No.: US 2020/0107530 A1
(43) Pub. Date: Apr. 9, 2020

(54) FISHING SIGNAL DETECTOR

(71) Applicant: Shimano Inc., Osaka (JP)

(72) Inventor: Satoshi IKEBUKURO, Osaka (JP)

(21) Appl. No.: 16/573,800

(22) Filed: Sep. 17, 2019

(30) Foreign Application Priority Data
Oct. 5, 2018 (JP) 2018-190254

(51) Int. Cl. A01K 97/12

(52) U.S. Cl. CPC A01K 97/125; G01H 1/12

(57) ABSTRACT

A fish strike notification device includes a detection signal acquisition unit, a vibration generator and a vibration instructor. The detection signal acquisition unit is configured to acquire a detection signal that is output from a sensor configured to detect vibration generated by at least one detection target that includes a fishing reel and a fishing rod. The vibration generator is attachable to a user and configured to generate vibrations. The vibration instructor is configured to output a vibration instruction signal to cause the vibration generator to generate the vibrations based on the detection signal acquired by the detection signal acquisition unit.

### CROSS-REFERENCE TO RELATED APPLICATIONS

This application claims priority to Japanese Patent Application No. 2018-190254, filed on Oct. 5, 2018. The entire disclosure of Japanese Patent Application No. 2018-190254 is hereby incorporated herein by reference.

### BACKGROUND

### Field of the Invention

The present invention relates to a fish strike notification device.

### Background Art

Conventional devices are known that that capable of detecting when a fish bites. These devices can include an acceleration sensor attached to the rod tip of a fishing rod that detects the vibration of a fishing line, and a microcomputer determines whether a fish bite has occurred depending on whether the vibration detected by the acceleration sensor has met a prescribed condition. If it is determined that a fish bite (strike) has occurred, timing for setting the hook is indicated audibly or by illumination of a lamp (for example, refer to Japanese Laid-Open Patent Publication No. Hei 10(1998)-004835).

In the technique disclosed in Japanese Laid-Open Patent Publication No. Hei 10(1998)-004835, when a fish strike is reported to the user, in addition to the acceleration sensor and the microcomputer, a device such as a sound output device or a lamp that is connected to the microcomputer is required. For example, during actual fishing, the user is required to carry these devices and perform such troublesome tasks as connecting the devices. That is, the fish strike notification system disclosed in Japanese Laid-Open Patent Publication No. Hei 10(1998)-004835 is overly large and cumbersome to use, and thus is unsuitable for personal use by the user.

### SUMMARY

In consideration of such circumstances, the object of the present invention is to provide a fish strike notification system that can be easily and personally used by a user.

One aspect of the present invention for solving the problem described above is a fish strike notification device comprising a detection signal acquisition unit that acquires a detection signal that is output from a sensor that detects the vibration generated by at least one detection target that includes a fishing reel and a fishing rod, and a vibration instruction unit that outputs a vibration instruction signal for causing a vibration generation unit, which is attached to the body of a user and which generates vibration, to generate vibrations based on the detection signal acquired by the detection signal acquisition unit.

According to the above-described configuration, it is possible to cause the vibration generation unit attached to the body of the user to generate vibrations in accordance with the vibrations being detected from the fishing reel or rod in response to a fish strike. It is thereby possible to provide a convenient and easy-to-handle device that notifies the user of a fish strike.

Another aspect of the present invention is that the fish strike notification device described above can include a body portion that includes the vibration generation unit and a mounting fixture for attaching the body portion to a prescribed part of the body of the user. According to the configuration described above, it is possible to provide a fish strike notification device, which reports the occurrence of a fish strike by vibration using the body portion that is attached to the body of the user, collectively as a set that includes a dedicated housing and the mounting fixture. The user can thereby conveniently use the fish strike notification device.

Another aspect of the present invention is that the fish strike notification device described above can include a first connecting portion on the detection target and a second connecting portion on the detection signal acquisition unit, which are connected to each other so as to be capable of detecting the vibration of the detection target by a sensor that is connected to the detection signal acquisition unit by wire, wherein the first connecting portion and the second connecting portion are configured such that the connection is released by the application to the connected portion of an external force that equals or exceeds a certain magnitude.

According to the configuration described above, when the sensor and the detection signal acquisition unit are connected by a cable, even if the detection target and the detection signal acquisition unit are physically connected such that the sensor can detect the vibration of the detection target, the connection is released if a force that equals or exceeds a certain magnitude is applied. As a result, when the distance between the detection target and the housing attached to the body of the user is greater than or equal to the length of the cable as a result of, for example, an unexpected movement by the user, the connection is released, so that breakage of the cable can be prevented.

As described above, according to the present invention, a fish strike notification system that can be easily and personally used by a user.

### BRIEF DESCRIPTION OF THE DRAWINGS

FIG. 1 is a view illustrating an example of an overall configuration of a fish strike notification system of a first embodiment.

FIG. 2 is a view illustrating an example of the overall configuration of the fish strike notification system of the first embodiment.

FIG. 3 is a view illustrating an example of a functional configuration of the fish strike notification system of the first embodiment.

FIG. 4 is a view illustrating an example of the overall configuration of the fish strike notification system of a second embodiment.

FIG. 5 is a view illustrating an example of the overall configuration of the fish strike notification system of the second embodiment.

FIG. 6 is a view illustrating an example of the overall configuration of the fish strike notification system of a third embodiment.

FIG. 7 is a view illustrating an example of the overall configuration of the fish strike notification system of the third embodiment.

FIG. 8 is a view illustrating an example of the functional configuration of the fish strike notification system of the third embodiment.

FIG. 9 is a view illustrating an example of the overall configuration of the fish strike notification system of a fourth embodiment.

FIG. 10 is a view illustrating an example of the overall configuration of the fish strike notification system of the fourth embodiment.

### DETAILED DESCRIPTION OF THE EMBODIMENTS

### First Embodiment

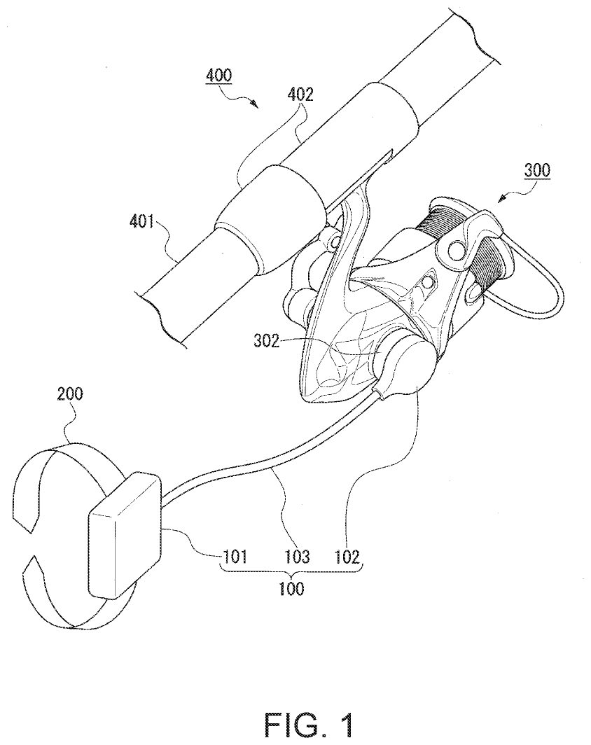

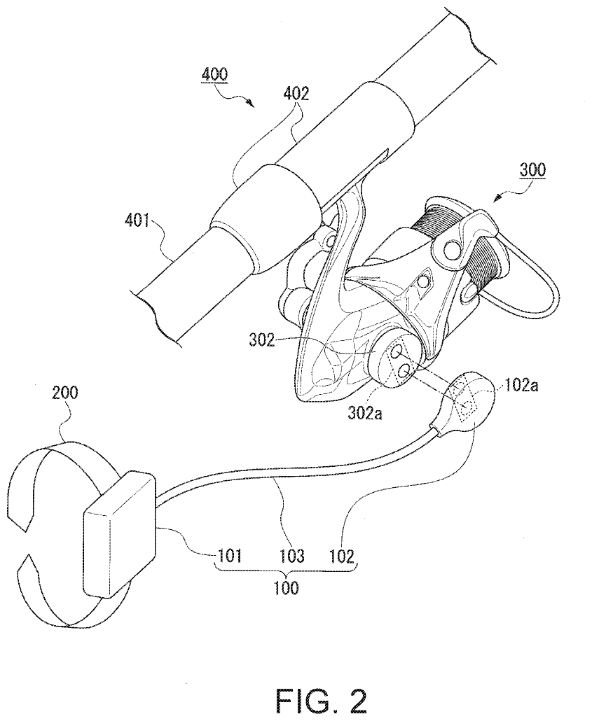

A configuration example of a fish strike notification system according to the present embodiment will be described with reference to FIGS. 1 and 2. FIGS. 1 and 2 illustrate an example of an overall configuration of the fish strike notification system of the present embodiment. In these Figures, a spinning reel, which is used as a fishing reel, is described as an example.

As shown in FIG. 1, the fish strike notification system of the present embodiment comprises a fish strike notification device 100. The fish strike notification device 100 includes a body portion 101 and a sensor unit (sensor) 102. The body portion 101 and the sensor unit 102 are connected by a cable 103.

A mounting fixture 200 is attached to the body portion 101 of the fish strike notification device 100. The mounting fixture 200 in the drawing has a belt shape made of, for example, a flexible resin, and can be attached to a prescribed part of the body, such as the user's wrists, arms, etc. As a result, the user can attach the body portion 101 of the fish strike notification device 100 to their body.

The configuration for attaching the mounting fixture 200 to the prescribed part of the body is not limited and may utilize, for example, a hook-and-loop fastener.

The sensor unit 102 of the fish strike notification device 100 is attached to a sensor unit attachment portion 302 of a spinning reel 300 (one example of the detection target). During actual fishing, the spinning reel 300 is attached to a reel mounting pedestal (reel seat) 402 disposed on a rod body 401 of the fishing rod 400, as shown in the figures.

As shown in FIG. 2, the attachment of the sensor unit 102 with respect to the sensor unit attachment portion 302 is carried out by connecting together a connecting portion 302a (one example of the first connecting portion) of the sensor unit attachment portion 302 and a connecting portion 102a (one example of the second connecting portion) of the sensor unit 102.

In the present embodiment, the connecting portion 302a and the connecting portion 102a can be connected by a magnetic force. Specifically, for example, the connecting portion 302a can include a magnet, and the connecting portion 102a can include a magnetic body in a position corresponding to the magnet disposed in the connecting portion 302a. Alternatively, the connecting portion 302a can include the magnetic body and the connecting portion 102a can include the magnet, or the connecting portion 302a and the connecting portion 102a can each include a magnet, and the polarities thereof set for mutual attraction.

The connection between the connecting portion 302a and the connecting portion 102a described above is released, for example, with the application of an external force that equals or exceeds a certain magnitude with respect to the force of mutual attraction between the magnet and the magnetic body.

The sensor unit 102 includes a sensor that detects vibration. Such a sensor of the sensor unit 102 may be, for example, an acceleration sensor or a piezoelectric element.

When one fishes using the fish strike notification device 100 according to the present embodiment, the user attaches the body portion 101 to their body and attaches the sensor unit 102, which is connected to the body portion 101 by the cable 103, to the sensor unit attachment portion 302 of the spinning reel 300.

When the fish strike notification device 100 is set as described above and utilized at the time as actual fishing, vibration corresponding to a fish strike is transmitted to the spinning reel 300 and also transmitted from the sensor unit attachment portion 302 to the sensor unit 102. With the transmission of the vibration in this manner, the sensor disposed in the sensor unit 102 detects the vibration corresponding to the fish strike.

The sensor unit 102 outputs a detection signal corresponding to the vibration detected by the sensor to the body portion 101 via the cable 103.

The body portion 101, equipped with, for example, a vibrator, is able to generate vibrations. The body portion 101 generates vibrations in response to the acquisition of the detection signal output from the sensor unit 102. Thus, the body portion 101 itself vibrates.

The user will know that there has been a fish strike by sensing the vibration of the body portion 101 attached to their body. That is, in the present embodiment, the body portion 101 vibrates to notify the user of the occurrence of a fish strike.

With the reporting of the fish strike in this manner, for example, the user can be informed of the occurrence of a fish strike, even if the rod is not manually held, and can take measures such as immediately setting the hook.

In addition, for example, if the fish strike is small, there are situations in which it is difficult to notice the fish strike even if the rod is manually held. Even in such situations, it is possible to clearly convey to the user that there has been a fish strike by a sufficiently intense vibration of the body portion 101. That is, the fish strike notification device 100 according to the present embodiment can amplify a small fish strike and convey the amplified fish strike to the user.

Additionally, as preparation for using the fish strike notification device 100 according to the present embodiment, the user need only attach the body portion 101 to their body with the mounting fixture 200 and attach the sensor unit 102 to the sensor unit attachment portion 302 of the spinning reel 300. That is, the fish strike notification system that includes the fish strike notification device 100 according to the present embodiment is suitable for a user's simple and personal use.

In addition, as described above, the connection between the connecting portion 302a of the spinning reel 300 and the connecting portion 102a of the fish strike notification device 100 using a magnetic force is capable of being released in response to the application of an external force that equals or exceeds a certain magnitude.

If the connection between the sensor unit 102 and the spinning reel 300 were formed by a structure that uses, for example, screws, the connection could not be released even if an external force of a certain magnitude were applied. In this situation, the following problem would arise. That is, if the user, who is fishing, moves unexpectedly, the spinning reel 300 and the body portion 101 of the fish strike notification device 100 would pull strongly against each other via the cable 103. In this situation, there is the possibility of the rod moving haphazardly, or of the cable 103 breaking, of damage to the connecting portion, etc. In contrast, in the present embodiment, even if the body portion 101 and the spinning reel 300 pull against each other, the connection between the connecting portion 302a and the connecting portion 102a can be released, so that the problem described above does not occur.

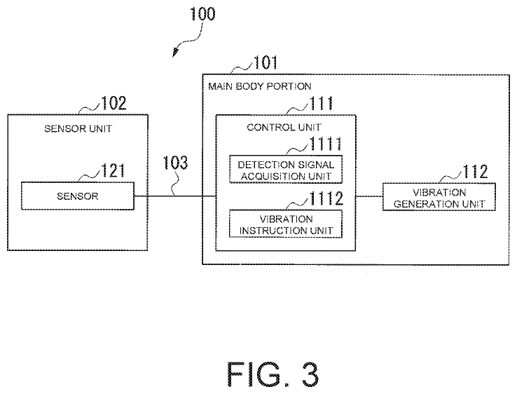

An example of a functional configuration of the fish strike notification system 100 will be described with reference to FIG. 3. The sensor unit 102 includes a sensor 121. The sensor 121 detects the vibration transmitted thereto. As illustrated in FIG. 1, due to the attachment of the sensor unit 110 to the spinning reel 300, the sensor 121 is able to detect the vibration that is generated in the spinning reel 300 in response to a fish strike.

The detection signal that is output by the sensor 121 is input to the body portion 101 via the cable 103.

The body portion 101 includes a control unit (controller) 111 and a vibration generation unit (vibration generator) 112. The control unit 111 and the vibration generation unit 112 can be powered, for example, by a battery (not shown) disposed in the body portion 101.

The control unit 111 executes the control in the fish strike notification device 100. The function as the control unit 111 is achieved by a CPU (Central Processing Unit) provided in the body portion 101 executing a program (computer program product). The control unit 111 includes a detection signal acquisition unit 1111 and a vibration instruction unit (vibration instructor) 1112.

The detection signal acquisition unit 1111 acquires a detection signal that is output from the sensor 121.

The vibration instruction unit 1112 outputs a vibration instruction signal for generating vibration to the vibration generation unit 112 based on the detection signal acquired by the detection signal acquisition unit 1111.

The vibration generation unit 112 generates vibration in accordance with the vibration instruction signal that is output from the vibration instruction unit 1112.

The vibration generation pattern of the vibration generation unit 112 corresponding to the instruction of the vibration instruction unit 1112 is not particularly limited. For example, the vibration instruction unit 1112 can output the vibration instruction signal such that the vibration generation unit 112 vibrates at a timing at which the detection signal of the sensor 121 indicates vibration corresponding to a fish strike. Alternatively, the vibration instruction unit 1112 can output the vibration instruction signal such that the vibration generation unit 112 continuously vibrates for a prescribed period of time at a timing at which the detection signal of the sensor 121 indicates vibration corresponding to a fish strike. Alternatively, the vibration instruction unit 1112 can output the vibration instruction signal such that the vibration generation unit 112 intermittently vibrates a prescribed number of times at a timing at which the detection signal of the sensor 121 indicates vibration corresponding to a fish strike.

### Second Embodiment

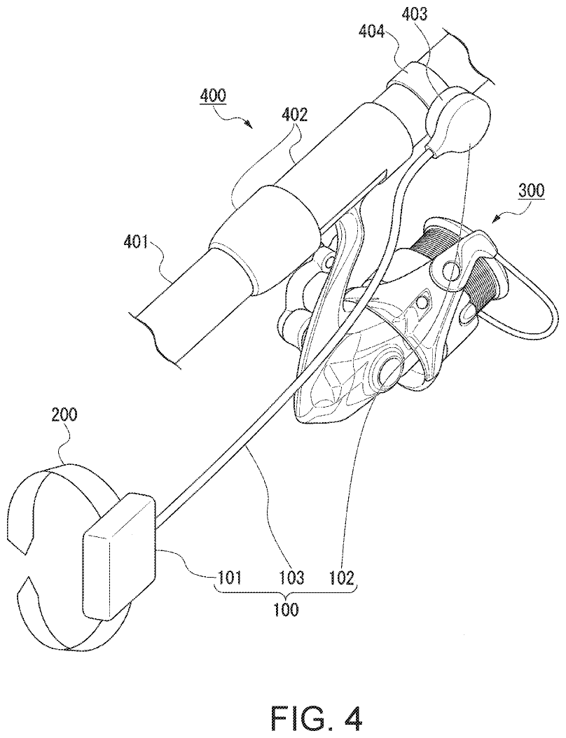

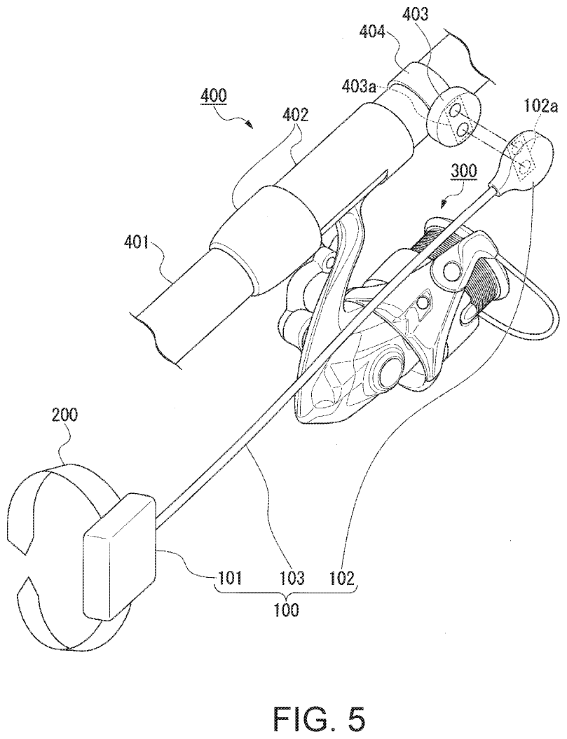

Next, the second embodiment will be described. FIGS. 4 and 5 illustrate an example of an overall configuration of the fish strike notification system of the second embodiment. In each of FIGS. 4 and 5, the same components as those used in FIGS. 1 and 2 have been assigned the same reference symbols and the descriptions thereof are omitted.

As shown in FIGS. 4 and 5, in the present embodiment, a sensor unit attachment portion 403 is disposed on the fishing rod 400 (one example of the detection target). In these figures, the sensor unit attachment portion 403 is attached to a mounting adapter 404. The mounting adapter 404 is attached to the rod body 401 of the fishing rod 400. The sensor unit attachment portion 403 is thereby fixedly attached to the fishing rod 400.

The manner of attachment of the sensor unit 102 to the sensor unit attachment portion 403 can be the same as that shown in FIG. 2. That is, as shown in FIG. 5, the sensor unit attachment portion 403 includes a connecting portion 403a (one example of the first connecting portion) having the same structure as the connecting portion 302a of FIG. 2, and the connecting portion 102a of the sensor unit 102 is connected to the connecting portion 403a. With such a configuration of the present embodiment, the sensor unit 102 detects vibration obtained by the fishing rod 400. That is, in the present embodiment, the body portion 101 generates vibrations in accordance with the vibrations obtained by the fishing rod 400 in response to a fish strike.

Thus, the user can be informed of the occurrence of a fish strike from the vibration of the body portion 101. In addition, since the preparation for the use of the fish strike notification device 100, such as attaching the body portion 101 to the body and attaching the sensor unit 102 to the fishing rod 400, is the same as the above-mentioned first embodiment, the present invention can be easily and personally used by the user.

### Third Embodiment

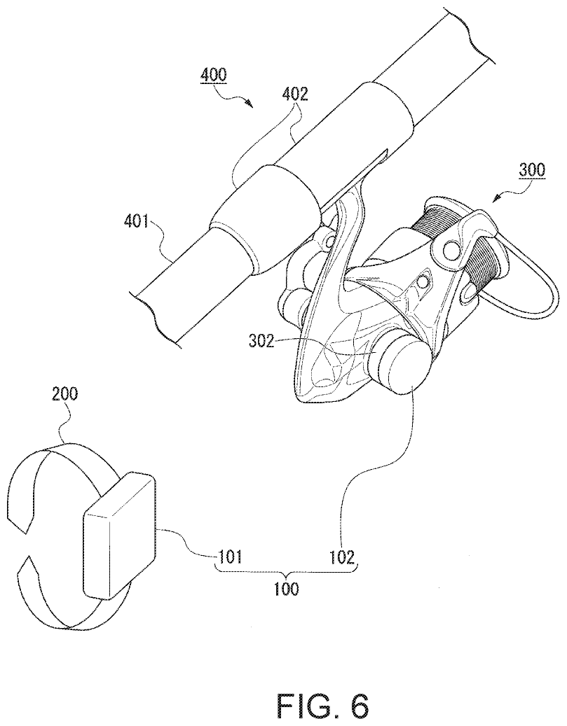

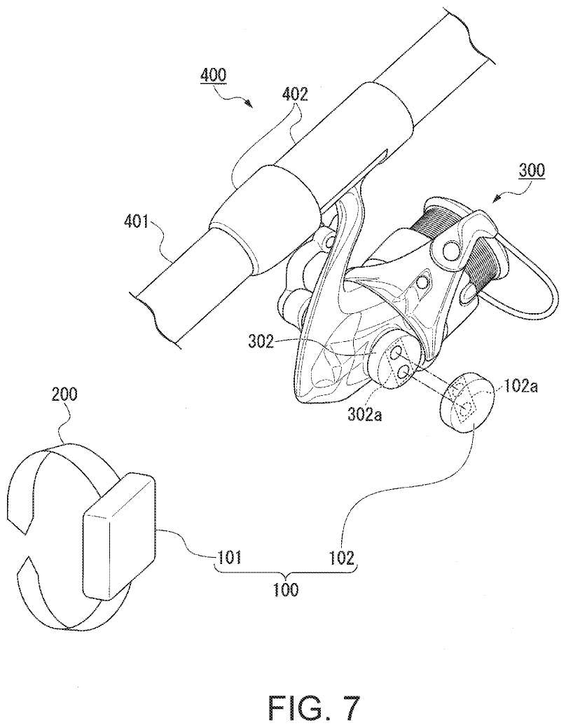

Next, the third embodiment will be described. FIGS. 6 and 7 illustrate an example of a configuration of the fish strike notification system of the third embodiment. In each of FIGS. 6 and 7, the same parts as those used in FIGS. 1 and 2 have been assigned the same reference symbols, and the descriptions thereof are omitted.

The fish strike notification device 100 of the above-mentioned first embodiment transmits the detection signal from the sensor unit 102 to the body portion 101 in wired fashion using the cable 103. In contrast, the fish strike notification device 100 of the present embodiment transmits the detection signal from the sensor unit 102 to the body portion 101 wirelessly. In the present embodiment, since the transmission of the detection signal from the sensor unit 102 to the body portion 101 is executed wirelessly, the cable 103 is omitted.

In addition, these figures illustrate the same example as FIG. 2 regarding the manner in which the sensor unit 102 of the fish strike notification device 100 is attached to the sensor unit attachment portion 302 of the spinning reel 300 in the present embodiment. In the second embodiment, since the sensor unit 102 and the body portion 101 are not connected by the cable 103, the attachment of the sensor unit 102 to the sensor unit attachment portion 302 can be achieved by a structure in which the connection is not released even if an external force that equals or exceeds a magnitude is applied, such as by using a structure utilizing screws.

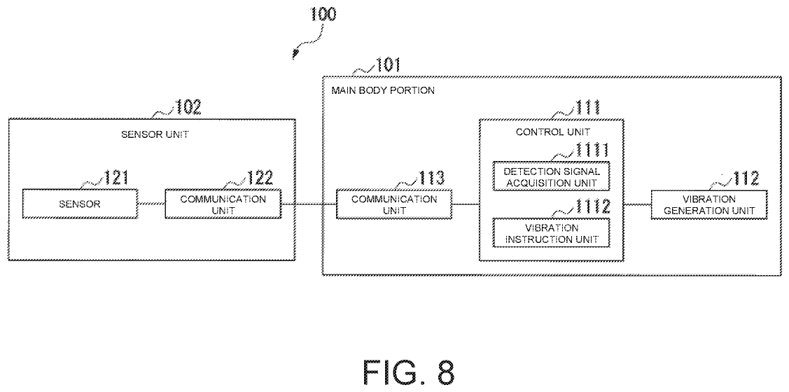

FIG. 8 shows an example of the functional configuration of the fish strike notification system 100 of the present embodiment. In the drawing, the same parts as those used in FIG. 3 have been assigned the same reference symbols, and the descriptions thereof are omitted.

A communication unit 122 is disposed in the sensor unit 102, and a communication unit 113 is disposed in the body portion 101. The communication unit 122 and the communication unit 113 communicate with each other wirelessly. The wireless communication method supported by the communication unit 122 and the communication unit 113 described above is not particularly limited, and one example of which is BLUETOOTH.

The detection signal that is output by the sensor 121 is input to the communication unit 122 of the sensor unit 102. The communication unit 122 transmits the input detection signal.

The communication unit 113 of the body portion 101 receives the detection signal that is transmitted from the communication unit 122. The detection signal acquisition unit 1111 according to the present embodiment acquires the detection signal received by the communication unit 113.

In addition, in this embodiment, since the sensor unit 102 and the body portion 101 communicate wirelessly, the sensor unit 102 and the body portion 101 may be individually operated using a battery as the power source.

### Fourth Embodiment

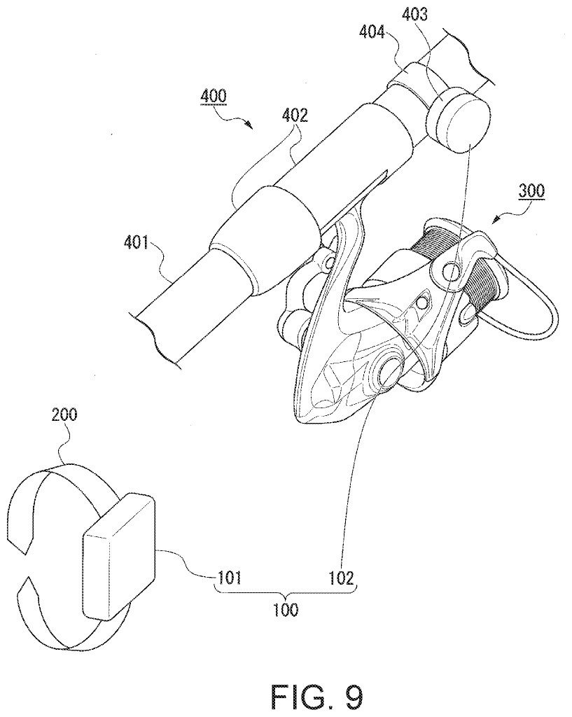

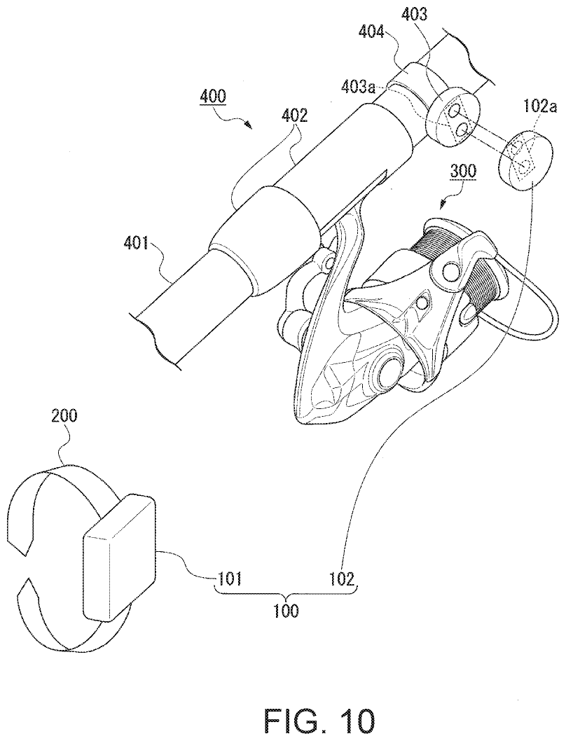

Next, the fourth embodiment will be described. FIGS. 9 and 10 illustrate an example of a configuration of the fish strike notification system of the fourth embodiment. In each of FIGS. 9 and 10, the same parts as those used in FIGS. 4 and 5 have been assigned the same reference symbols, and the descriptions thereof are omitted.

The fish strike notification device 100 of the fish strike notification system according to the present embodiment transmits the detection signal from the sensor unit 102 to the body portion 101 wirelessly, in the same manner as in the third embodiment. In addition, in the fish strike notification system according to the present embodiment, the sensor unit 102 is attached to the fishing rod 400 in the same manner as in the second embodiment.

The example of the functional configuration of the fish strike notification device 100 according to the present embodiment can be the same as that shown in FIG. 8.

### Complementary and Modification Examples

Complementary or modification examples of each of the embodiments described above will be described below.

In each of the embodiments described above, the vibration instruction unit 1112 can cause the vibration generation unit 112 to generate vibrations of uniform intensity, regardless of the amplitude of the detection signal corresponding to the magnitude of the detected vibration.

Alternatively, the vibration instruction unit 1112 can change the intensity of the vibrations that are generated by the vibration generation unit 112 in accordance with the amplitude of the detection signal.

In each of the embodiments described above, a display, illumination of an indicator such as an LED (Light-Emitting Diode), sound, and the like may be used in combination to report the fish strike, in accordance with the vibrations generated by the vibration generation unit 112. Such notification by a display, illumination of an indicator, sound, and the like can be carried out by the body portion 101, or may be carried out by the sensor unit 102.

In addition, for example, the body portion 101 can include an operating unit such that various operations relating to the notification of the fish strike can be carried out. Alternatively, various operations of the fish strike notification device 100 can be carried out by an operation at a terminal, such as a smartphone or a personal computer, which is wired or wirelessly connected to the body portion 101.

Examples of operations with respect to the body portion 101 include selecting the pattern or the intensity of the vibrations that are generated by the vibration generation unit 112 in accordance with the notification of a fish strike, and on/off control of the combined use of notification via a display, illumination of an indicator, sound, etc.

In the third and fourth embodiments, the sensor unit 102 is independent and not connected to the body portion 101 via the cable. Therefore, for example, the sensor unit can be easily lost when the sensor unit is removed from the sensor unit attachment portions 302, 403, etc.; thus, the sensor unit 102 can be connected to the body portion 101, the spinning reel 300, or the fishing rod 400 by a wire, a chain, or the like.

In each of the above-described embodiments, the configuration with which the connection between the connecting portion 102a and the connecting portion 302a or 403a is released by application thereto of an external force that equals or exceeds a certain magnitude is not limited to the example in which a magnet is used. For example, the connecting portion 102a and the connecting portion 302a or 403a can be fitted by utilizing the flexibility of resin, and the fitting may be configured to be released in response to the application of an external force that equals or exceeds a certain magnitude to the fitted location. In addition, the connecting portion 102a and the connecting portion 302a or 403a can be connected by an adhesive having suitable adhesiveness.

The fish strike notification device 100 can be provided to the user as a set that includes, for example, the dedicated body portion 101 and the sensor unit 102 (in the first and second embodiments, the cable 103 can also be included in the set). In these embodiments, the mounting fixture 200 can also be included in the set and provided. In this situation, the user can easily obtain the fish strike notification device 100 as a module from a fishing tackle shop, for example.

Alternatively, the body portion 101 of the fish strike notification device 100 can be a general-purpose terminal, such as a smartphone in the user's possession. In this embodiment, the fish strike notification device 100 can be configured to connect to the smartphone and the sensor unit 102 with a cable supported by a prescribed communication standard, such as USB, or by wireless communication such as BLUETOOTH. In this embodiment, the smartphone may function as the body portion 101 of the fish strike notification device 100 by installing a prescribed application on the smartphone. In addition, in this embodiment, the mounting fixture 200 can utilize a band, or the like, for attaching the smartphone to part of the body, such as a wrist or an arm.

In each of the embodiments described above, one sensor unit 102 can be attached to either the spinning reel 300 or the fishing rod 400. However, the fish strike notification device 100 according to the present embodiment can be configured such that, for example, two sensor units 102 are connected to the body portion 101, after which the two sensor units 102 are respectively attached to the spinning reel 300 and the fishing rod 400. In this embodiment, for example, the detection signal acquisition unit 1111 acquires the detection signal from each of the two sensor units 102, and the vibration instruction unit 1112 can cause the vibration generation unit 112 to generate vibrations based on the acquired detection signals from the two sensor units 102. Alternatively, the detection signal acquisition unit 1111 can selectively acquire the detection signal from one of the two sensor units 102, and the vibration instruction unit 1112 can cause the vibration generation unit 112 to generate vibrations based on the acquired detection signal from the one of the two sensor units 102. In this embodiment, for example, the detection signal acquisition unit 1111 can acquire the detection signal from the sensor unit 102 that is specified by an operation, or the sensor unit 102 from which the detection signal should be acquired by the detection signal acquisition unit 1111 can be determined based on, for example, the state, etc., of the detection signal.

Furthermore, a plurality of the sensor units 102 can be attached to at least one of the spinning reel 300 and the fishing rod 400, and the vibration generation unit 112 can generate vibrations in accordance with the vibrations detected by these sensor units 102.

The position at which the sensor unit 102 is attached to the spinning reel 300 or the fishing rod 400 is not limited to the position illustrated in each of the embodiments. For example, when the sensor unit 102 is attached to the fishing rod 400, the sensor unit 102 can be attached to the rod end position of the fishing rod 400.

In each of the embodiments described above, the sensor 121 that detects the vibration can be disposed on the sensor unit attachment portion 302, 403. That is, the sensor 121 can be disposed on the spinning reel 300 or the fishing rod 400. In this embodiment, by attachment to the sensor unit attachment portions 302, 403, the part as the sensor unit 102 can include a terminal to which the detection signal of the sensor 121 is input, and the input detection signal can be output to the body portion 101,

In addition, in the first and second embodiments, the configuration for connecting the body portion 101 to the spinning reel 300 or the fishing rod 400 can, for example, be in the middle of the cable 103. In this embodiment, since the body portion 101 is physically connected to the spinning reel 300 or the fishing rod 400 by the connecting portion, an electrical connection is also carried out for transmission of the detection signal.

The fishing reel in the fish strike notification system according to the present embodiment can be another type of fishing reel besides a spinning reel, such as a bait reel or an electric reel.

The above-described processing of the fish strike notification device 100 can be carried out by storing a program (computer program product) for realizing the above-described functions of the fish strike notification device 100 in a storage medium that can be read by a computer and cause a computer system to read and execute the program that is stored in the storage medium. Here, “causing a computer system to read and execute the program that is stored in the storage medium” includes the installation of the program in the computer system. The “computer system” here includes the OS and hardware such as peripheral devices. In addition, the “computer system” may also include a plurality of computer devices that are connected via a network, including the Internet and communication lines such as WAN, LAN, and dedicated lines. Additionally, the “storage medium that can be read by a computer” refers to storage devices such as portable media such as flexible discs, magnetoöptical discs, ROMs, and CD-ROMs, and hard disks that are incorporated in a computer system. In this manner, the storage medium on which the program is stored may be a non-transitory storage medium, such as a CD-ROM. In addition, the storage medium includes storage media provided internally or externally that can be accessed from a distribution server in order to distribute the program. The code of the program that is stored in the storage medium of the distribution server may be different from the code of the program that is in a format that can be executed by the terminal device. That is, as long as the program can be downloaded from the distribution server and installed in a format that can be executed by the terminal device, the format in which the program is stored in the distribution server is not limited. The program may be divided into a plurality of segments and merged on the terminal device after being downloaded at different timings, or the distribution server that distributes each of the divided programs may be different. Moreover, the “storage medium that can be read by a computer” shall also include media that retain the program for a set period of time, such as volatile memory (RAM) within the computer system which acts as the server or the client when the program is transmitted via the network. In addition, the above-described program may realize some of the functions described above. Moreover, it may be a program that can realize the functions described above through combination with a program already stored in the computer system, i.e., a so-called difference file (difference program).

What is claimed is:

1. A fish strike notification device, comprising:
a detection signal acquisition unit configured to acquire a detection signal that is output from a sensor configured to detect vibration generated by at least one detection target that includes a fishing reel and a fishing rod;
a vibration generator attachable to a user and configured to generate vibrations; and
a vibration instructor configured to output a vibration instruction signal to cause the vibration generator to generate the vibrations based on the detection signal acquired by the detection signal acquisition unit.

2. The fish strike notification device according to claim 1, further comprising
a body portion that includes the vibration generator, and
a mounting fixture configured to attach the body portion to a prescribed part of the user.

3. The fish strike notification device according to claim 1, further comprising
a first connecting portion configured to be disposed on the detection target and a second connecting portion configured to be disposed on the detection signal acquisition unit, the first and second connecting portions being capable of being connected to each other so as to be capable of enabling the vibration of the detection target detected by the sensor to be acquired by the detection signal acquisition unit by wire, the first connecting portion and the second connecting portion being configured such that the connection therebetween is capable of being released by application of an external force that equals or exceeds a certain magnitude.
